(19) United States
(12) Patent Application Publication
(10) Pub. No.: US 2010/0057321 A1
(43) Pub. Date: Mar. 4, 2010

(54) METHOD FOR PROVIDING ASSISTANCE DURING A PASSING MANEUVER OF A MOTOR VEHICLE

(76) Inventors: Martin Randler, Immenstaad (DE); Werner Urban, Vaihingen/Enz (DE)

Correspondence Address: KENYON & KENYON LLP, ONE BROADWAY, NEW YORK, NY, 10004, US

(21) Appl. No.: 12/227,988

(22) PCT Filed: Jun. 15, 2007
(86) PCT No.: PCT/EP2007/055940

§ 371 Date: Nov. 20, 2009

(30) Foreign Application Priority Data
Jul. 19, 2006 (DE) 10 2006 033 487.6

(51) Int. Cl. B60W 30/16

(52) U.S. Cl. 701/96

(57) ABSTRACT

In a method for providing assistance during a passing maneuver of a motor vehicle having an adaptive cruise control device, the following method steps are used: a preceding object is ascertained as a target object, a distance of the motor vehicle to the target object is ascertained, a relative velocity between the motor vehicle and the target object is ascertained, and a plausibility check corridor is narrowed as a function of the distance and the relative velocity.

### BACKGROUND OF THE INVENTION

1. Field of the Invention

The present invention relates to a method and a device for providing assistance during a passing maneuver of a motor vehicle having an adaptive cruise control device.

2. Description of Related Art

A method and a device having an adaptive cruise control device are described in the Bosch manual, yellow series, “Adaptive Fahrgeschwindigkeitsregelung ACC” [Adaptive Cruise Control], Ed. 2002, ISBN 3-7782-2034-9. ACC stands for the term Adaptive Cruise Control. Adaptive Cruise Control extends the cruise control in such a way that the vehicle velocity is adapted to the slower preceding vehicles if these are measured in the detection range by an object detection sensor and are in the anticipated travel-path area. The object detection sensor is a distance sensor and is implemented using a radar sensor or lidar sensor, which scans using a laser. The anticipated travel-path area is hereinafter also referred to as the tunnel, corridor, or plausibility check corridor. If a motor vehicle is adapted to the velocity of a preceding vehicle with the aid of an adaptive cruise control (ACC) system, the preceding motor vehicle is referred to as the target or followed object or as the relevant object and the vehicle whose velocity is adapted is referred to as ACC-controlled vehicle or, shortly, as the ACC vehicle. Recognizing and classifying a preceding vehicle as the target object in particular are referred to as plausibility check.

For the plausibility check of the relevant object, a certain average width of the plausibility check corridor is assumed with the target conflict that, on the one hand, the plausibility check corridor is not too large to avoid interference from neighboring lanes, and, on the other hand, it is sufficiently large to allow preceding vehicles in the host vehicle's travel-path area to be recognized as target objects as early as possible. In approaching a vehicle located in the anticipated travel-path area, the ACC vehicle is braked in such a way that, when reaching the set desired time window, an excess velocity with respect to the preceding vehicle is reduced. Should the ACC vehicle remain in this pursuing mode, this approach characteristic represents a desired and therefore pleasant system response. In the case when the driver of the motor vehicle does not intend to be in the pursuing mode and therefore starts to pass already when approaching the preceding vehicle, automatic braking should be interrupted as rapidly as possible and the ACC vehicle should be promptly accelerated again to the set velocity.

A generic method and a generic device for providing assistance during a passing maneuver of a motor vehicle having an adaptive cruise control device is known from published German patent document DE 101 14 187. A plurality of criteria is provided for recognizing an intent of the vehicle's driver to pass; these include in particular operating the turn signal. A passing velocity is, among other things, calculatable as a function of the preceding motor vehicles traveling in the passing lane. A passing assistant is thus described which, when the turn signal is operated, shifts the plausibility check corridor in the direction of the passing lane and thus ensures that the preceding vehicle is released more rapidly during the lane-change operation. It is not taken into account that in speedy driving with frequent approach and lane-change situations the turn signal is often not operated. In these lane-change situations the ACC vehicle is braked until the preceding vehicle recognized as the target object leaves the plausibility check corridor or, in other words, until a sufficiently large lateral offset exists with respect to the preceding vehicle, which is then released. Often the approach-braking operation is not terminated until the ACC vehicle is completely in the passing lane. This is implausible for the vehicle's driver because the driver in this case expects to release the vehicle to be passed as early as during the lane change, i.e., when crossing the lane boundary line. The traffic following behind is also irritated because the preceding vehicle prepares to pass, yet it still brakes in the free passing lane.

### BRIEF SUMMARY OF THE INVENTION

An object of the present invention is to ensure rapid passing in ACC-controlled operation when the turn signal is not operated. In particular, a measure independent of the turn signal should be determined for the intent to pass.

The following method steps are used in the procedure: a preceding object is ascertained as the target object, a distance of the motor vehicle to the target object is ascertained, a relative velocity between the motor vehicle and the target object is ascertained, and a plausibility check corridor is narrowed as a function of the distance and the relative velocity.

If a preceding motor vehicle travels in an anticipated travel-path area of the ACC-controlled vehicle, the preceding vehicle is recognized as the target object. A distance to this object is measured and a distance value is thus ascertained. This distance value is compared with a predefinable value which is in the range of 75 m to 90 m.

At the same time, the relative velocity of the two vehicles with respect to each other is ascertained. This may take place, on the one hand, via continuous distance measurement and on the basis of the continuously measured distances a relative velocity of the two vehicles with respect to each other may be ascertained. On the other hand, there are also radar devices which directly ascertain the relative velocity between the two vehicles on the basis of the reflected radar radiation.

If the distance value drops below the predefined value and the two vehicles get closer to each other, the plausibility check corridor is narrowed. For this purpose, the regulator has at least one microprocessor and at least one memory in which an array of characteristics may be stored. Distances and relative velocities define the array of characteristics and the plausibility check corridor is narrowed by a predefinable value as a function of a predefinable relative velocity value and a predefinable distance value. This means that, if a predefinable pair of distance/relative velocity values is reached or exceeded, the plausibility check corridor is narrowed by a constant. The width of the plausibility check corridor is reduced. The preceding vehicle is released.

As an alternative, an approach-criticality measure is ascertained as a function of the target object distance and the relative velocity between the target object and the ACC-regulated vehicle. A measure which is [inversely] proportional to the squared distance of the target object and directly proportional to the squared relative velocity has been found useful here. The criticality value results from the quotient of the square of the relative velocity and the square of the distance.

Criticality=v_{Rel}²/d²

A measure of the probability of passing is thus ascertained in a first step. A narrowing value is ascertained as a function of the value of the probability of passing. Narrowing takes place step-by-step or, in other words, slidingly. With the distance being reduced and the relative velocity being increased, the absolute value of narrowing increases, i.e., the width of the plausibility check corridor is reduced. The preceding vehicle is released already at a small lateral offset. In a second step, the absolute value of narrowing, hereinafter also referred to as dycCorrimplicitovertake, is ascertained for the plausibility check corridor. For low criticality there is no narrowing.

If the target object is approached in such a way that the ACC regulator is no longer able to regulate and thus an evasive maneuver is very likely to occur, the criticality is maximum. A maximum criticality is given by a value equal to or greater than 0.16* (1/s²). The traffic lane width is then narrowed by a maximum of one-half of the vehicle's width.

A measure of the narrowing may be calculated using a second constant having an absolute value of 5.0 as follows:

dycCorrimplicitOvertake [m]=5.0* v_{Rel}²/d² [1/sec²]

In situations with assumed passing intent, the plausibility check corridor is thus narrowed on the side facing away from the passing lane so as to assign the vehicle to be passed to the adjacent lane and thus to force a more rapid release of the target object. This ensures a smooth passing maneuver even if no turn signal is set.

The travel-path offset, i.e., the lateral offset of the target object relative to the precalculated travel-path of the ACC vehicle is advantageously taken into account. Only if a certain minimum travel-path offset is present may it be assumed that a subsequent passing maneuver will be executed. This is the case when the ACC vehicle travels offset by one-half of a vehicle width with respect to the target object in the direction of the passing lane. It is also possible to assume an intent to pass only as a function of the travel-path offset. If the travel-path offset value is greater than a predefinable value, the plausibility check corridor is narrowed by a constant. As an alternative, the plausibility check corridor is narrowed gradually as a function of the value of the travel-path offset. The narrowing value becomes greater with increasing travel-path offset.

The passing assistance is advantageously coupled to the traffic situation. In a right-hand traffic system only the right-hand side of the plausibility check corridor is adjusted and in a left-hand traffic system only the left-hand side is adjusted accordingly.

### BRIEF DESCRIPTION OF THE DRAWING

FIG. 1 shows an ACC-regulated vehicle behind a preceding vehicle.

### DETAILED DESCRIPTION OF THE INVENTION

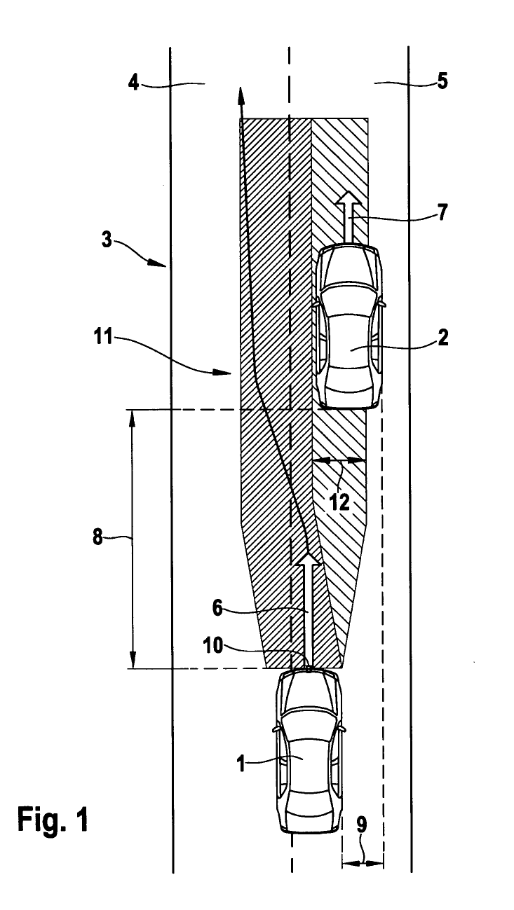

FIG. 1 shows an ACC-regulated vehicle 1 behind a preceding vehicle 2 on a road 3 having two traffic lanes 4 and 5. The two vehicles 1, 2 move in the same directions 6 and 7, directional arrows 6 and 7 as vectors specifying the velocities via their lengths. Vector 6 of the ACC-regulated vehicle is longer than vector 7 and thus the velocity is greater than that of preceding vehicle 2. The ACC-regulated motor vehicle has a distance 8 and a travel-path offset 9 with respect to preceding vehicle 2. In a front area, ACC-regulated vehicle 1 has a regulator 10 having a radar unit. Radar beams sweep a horizontal plane in front of the vehicle and a plausibility check corridor 11 is selected from the horizontal plane. Vehicles 2 traveling in front of ACC-regulated vehicle 1 in plausibility check corridor 11 are classified as relevant objects. When ACC-regulated vehicle 1 approaches preceding vehicle 2 at a predefinable velocity and the distance drops below a predefinable value, plausibility check corridor 11 is reduced by a narrowing value 12 and thus preceding vehicle 2 is released.

In the following table, the correction value is given as a function of the target object's distance and the target object's relative velocity:

| v_{Rel} | d [m] | | | | |
|---|---|---|---|---|---|
| [m/s] | 100 | 75 | 50 | 25 | 10 |
| 0 | 0 | 0 | 0 | 0 | 0 |
| −5 | 0.0125 | 0.022 | 0.05 | 0.2 | 1.25 |
| −10 | 0.05 | 0.069 | 0.2 | 0.8 | 5 |
| −20 | 0.2 | 0.36 | 0.8 | 3.2 | 20 |
| −30 | 0.45 | 0.8 | 1.8 | 7.2 | 45 |

Table values having a value of 1.8 or higher are not attained even in risky driving.

1-10. (canceled)

11. A method for providing assistance during a passing maneuver of a motor vehicle having an adaptive cruise control device, comprising:
ascertaining a preceding object as a target object;
ascertaining a distance of the motor vehicle to the target object;
ascertaining a relative velocity between the motor vehicle and the target object; and
narrowing a plausibility check corridor as a function of the distance and the relative velocity, wherein the plausibility check corridor is an area of anticipated travel-path of the motor vehicle.

12. A method for providing assistance during a passing maneuver of a motor vehicle having an adaptive cruise control device, comprising:
ascertaining a preceding object as a target object;
ascertaining a distance value of the motor vehicle to the target object;
comparing the distance value to a first predefined value;
ascertaining a relative velocity value between the motor vehicle and the target object;
comparing the relative velocity value to a second predefined value; and
narrowing a plausibility check corridor by a narrowing value as a function of the distance value comparison and the relative velocity value comparison, wherein the plausibility check corridor is an area of anticipated travel-path of the motor vehicle.

13. A method for providing assistance during a passing maneuver of a motor vehicle having an adaptive cruise control device, comprising:
ascertaining a preceding object as a target object;
ascertaining a distance of the motor vehicle to the target object;
ascertaining a relative velocity between the motor vehicle and the target object;
ascertaining a travel-path offset between the motor vehicle and the target object; and
narrowing a plausibility check corridor as a function of the distance, the relative velocity, and the travel-path offset, wherein the plausibility check corridor is an area of anticipated travel-path of the motor vehicle.

14. A method for providing assistance during a passing maneuver of a motor vehicle having an adaptive cruise control device, comprising:
ascertaining a preceding object as a target object;
ascertaining a distance value of the motor vehicle to the target object;
comparing the distance value to a first predefined value;
ascertaining a relative velocity value between the motor vehicle and the target object;
comparing the relative velocity value to a second predefined value;
ascertaining a travel-path offset value between the motor vehicle and the target object;
comparing the travel-path offset value to a third predefined value; and
narrowing a plausibility check corridor by a narrowing value as a function of the distance value comparison, the relative velocity value comparison and the travel-path offset value comparison, wherein the plausibility check corridor is an area of anticipated travel-path of the motor vehicle.

15. The method as recited in claim 12, wherein the narrowing value is a constant.

16. The method as recited in claim 14, wherein the narrowing value is a constant.

17. The method as recited in claim 12, wherein the narrowing value is selected as a function of the comparisons.

18. The method as recited in claim 14, wherein the narrowing value is selected as a function of the comparisons.

19. The method as recited in claim 12, wherein the narrowing value is the product of a selected constant multiplied by a quotient of the square of the relative velocity value and the square of the distance value.

20. The method as recited in claim 14, wherein the narrowing value is the product of a selected constant multiplied by a quotient of the square of the relative velocity value and the square of the distance value.

21. A method for providing assistance during a passing maneuver of a motor vehicle having an adaptive cruise control device, comprising:
ascertaining a preceding object as a target object;
ascertaining a travel-path offset between the motor vehicle and the target object; and
narrowing a plausibility check corridor as a function of the travel-path offset, wherein the plausibility check corridor is an area of anticipated travel-path of the motor vehicle.

22. A method for providing assistance during a passing maneuver of a motor vehicle having an adaptive cruise control device, comprising the following method steps:
ascertaining a preceding object as a target object;
ascertaining a travel-path offset value between the motor vehicle and the target object;
comparing the travel-path offset value to a predefined value; and
narrowing a plausibility check corridor by a narrowing value as a function of the travel-path offset value comparison, wherein the plausibility check corridor is an area of anticipated travel-path of the motor vehicle.

23. A device for providing assistance during a passing maneuver of a motor vehicle, wherein the motor vehicle has an adaptive cruise control device, comprising:

23. A device for providing assistance during a passing maneuver of a motor vehicle, wherein the motor vehicle has an adaptive cruise control device, comprising:
ascertaining a preceding object as a target object;
ascertaining a distance of the motor vehicle to the target object;
ascertaining a relative velocity between the motor vehicle and the target object; and
narrowing a plausibility check corridor as a function of the distance and the relative velocity, wherein the plausibility check corridor is an area of anticipated travel-path of the motor vehicle.
